(19) United States
(12) Patent Application Publication
(10) Pub. No.: US 2017/0335788 A1
(43) Pub. Date: Nov. 23, 2017

(54) Method for checking a parameter correlating with a pressure in a pressure-dependent fluid-conveying system, control device and fluid-conveying system

(71) Applicant: Continental Automotive GmbH, Hannover (DE)

(72) Inventor: Gerald BEHRENDT, Frankfurt am Main (DE)

(21) Appl. No.: 15/523,878

(22) PCT Filed: Nov. 2, 2015
(86) PCT No.: PCT/EP2015/075476

§ 371 Date: May 2, 2017

(30) Foreign Application Priority Data
Nov. 3, 2014 (DE) 10 2014 222 404.7

(51) Int. Cl. F02D 41/30; F02M 37/08; F02D 41/20; F02D 41/22

(52) U.S. Cl. CPC F02D 41/3082; F02M 37/08; F02D 2041/2058; F02D 2041/224; F02D 2200/0604; F02D 2041/225

(57) ABSTRACT

A method for checking a parameter correlating with a pressure in a pressure-dependent fluid delivery system, the fluid delivery system having: a current-controlled electric motor controlled by a motor controller, and a fluid pump driven by the electric motor, includes: determining a rotational speed of the electric motor; determining a current of the electric motor, by reading out an activation current of the motor controller; calculating a pressure value as a function of the rotational speed and the current of the electric motor; and comparing the calculated pressure value with the parameter.

### CROSS-REFERENCE TO RELATED APPLICATIONS

This is a U.S. national stage of application No. PCT/EP2015/075476, filed on 2 Nov. 2015, which claims priority to the German Application No. 10 2014 222 404.7 filed 3 Nov. 2014, the content of both incorporated herein by reference,.

### BACKGROUND OF THE INVENTION

### 1. Field of the Invention

The invention relates to fuel delivery systems used in motor vehicles.

### 2. Related Art

Fluid delivery systems are used, for example, as fuel delivery systems in motor vehicles and are generally dependent on the pressure in some way. For example, the fuel delivery system is a predelivery system, for example for providing a fuel to an injection system, a so-called fuel rail system. Here, pressures in the range from 2 to approximately 6 bar are common. The pressure within the fuel system must not fall below a certain value, because otherwise a permanent fuel supply cannot be ensured. On the other hand, for safety reasons, the pressure also must not exceed a maximum value. To protect the fuel delivery system, use is sometimes made of pressure sensors. A pressure sensor measures a pressure of a fuel system at a single location. Fuels that are used, such as, for example gasoline, may however give rise to pressures that vary over time within a fuel system. Furthermore, owing to different components in the fuel system, such as, for example, fuel filters, the pressure there may differ. Depending on the location of the measurement of the pressure and the components used and the conditions, values of the pressure sensor may possibly be inconsistent, but are nevertheless used for regulation. An additional check of the pressure in the fuel delivery system is desirable.

### SUMMARY OF THE INVENTION

It is an object of the invention to solve the above-described problem by a method for checking a parameter correlating with a pressure in a pressure-dependent fluid delivery system, by a control unit or by a fluid delivery system.

According to a first aspects the object may achieved by a method for checking a parameter correlating with a pressure in a pressure-dependent fluid delivery system. The fluid delivery system comprises an electric motor controlled by a motor controller. The fluid delivery system also comprises a fluid pump operated by an electric motor. The method comprises:
determining a rotational speed of the electric motor;
determining a current of the electric motor, in particular reading out an activation current of the motor controller;
calculating a pressure value as a function of the rotational speed and the current of the electric motor; and
comparing the calculated pressure value with the parameter.

Parameters are to be understood to mean pressure values which, in a fluid delivery system, form limit values or define characteristic properties. For example, one parameter is a negative-pressure threshold, for the purposes of determining whether a negative pressure prevails. The negative-pressure threshold has, for example a magnitude of 0.5 bar. Further parameters are, for example, a positive-pressure threshold, a characteristic value for dry running of the fluid pump, a limit value beyond which a fluid pressure in the fluid delivery system becomes unstable, a characteristic pressure value that (inter alia also in a manner dependent on a setpoint delivery rate) is indicative of a leak, or a characteristic pressure value that indicates so-called “gassing” of the fluid, specifically of a fuel,

By the comparing, it is verified that the calculated pressure value falls within predetermined limits. Various values may be used as parameters in order, in each case, to check a different application dependent on the pressure present in the fluid delivery system. The step of determining of the rotational speed of the electric motor may be satisfied by a presetting of the rotational speed of the electric motor. The electric motor may be a current-controlled electric motor. The activation current of the electric motor may, in this case, be, for example, a phase current, a foot-point current or the like.

In an advantageous embodiment of the invention, the following is additionally performed;
checking a result from the step of the comparing for plausibility on the basis of a predetermined reference value.

By the checking for the plausibility in a fluid delivery system, the reliability of the fluid delivery system is increased.

In a further advantageous embodiment, a result from the comparing is characteristic of at least one of the following events:
setting of a negative pressure in the fluid delivery system;
setting of a positive pressure in the fluid delivery system;
destabilization of a fluid pressure in the fluid delivery system;
dry running of the fluid pump;
occurrence of gas bubbles in the fluid delivery system, in particular gassing;
occurrence of a leak in the fluid delivery system.

The check of the abovementioned events is advantageous for reliability reasons. Here, a conventional pressure sensor is often not sufficient.

In a further advantageous embodiment, the fluid delivery system is pressure-controlled or rotational-speed-controlled.

The method may be used equally in a pressure-controlled fluid delivery system or in a rotational-speed-controlled fluid delivery system. Whereas use in a fluid delivery system, which is pressure-controlled, yields additional plausibility for the measured pressure values, it is the case in a rotational-speed-controlled delivery system, in which no pressure sensor is required, that additional reliability is achieved by the method, because pressure values can be obtained that could not be checked otherwise.

In a further advantageous refinement, the fluid delivery system comprises a calibration valve arranged at an outlet aide of the fluid pump and which opens in a manner dependent on a predetermined pressure in order to provide a pressure-dependent calibration function. The step of the calculating is, in this case, additionally dependent on the calibration function.

By the calibration valve, it is possible for a pressure dependency to be established independently of sensors.

According to a second aspect of the invention, the object may be achieved by a controller for a gasoline fuel delivery system or a diesel fuel delivery system, which controller is configured to carry out a method according to the first aspect.

According to a third aspect of the invention, the object may be achieved by a fluid delivery system. The fluid delivery system comprises an electric motor, a motor controller and a fluid pump, wherein the electric motor is configured to drive the fluid pump. The motor control unit is configured to activate the electric motor with an activation current on the basis of a throughflow regulation algorithm, wherein monitoring and/or plausibility checking of the fluid delivery system is performed by a method according to the first aspect.

The advantages relating to the controller according to the second aspect and relating to the fluid delivery system according to the third aspect substantially correspond to the advantages described with regard to the corresponding method.

In one advantageous embodiment, additionally a calibration valve is arranged at an outlet side of the fluid pump and opens in a manner dependent on a predetermined pressure.

### BRIEF DESCRIPTION OF THE DRAWINGS

The invention will be discussed in more detail below on the basis of FIGS. and exemplary embodiments. In the FIGS:

FIG. 1 shows a fluid delivery system (schematic illustration); and

FIG. 2 shows a flow diagram of a method according to an embodiment of the invention.

### DETAILED DESCRIPTION OF THE PRESENTLY PREFERRED EMBODIMENTS

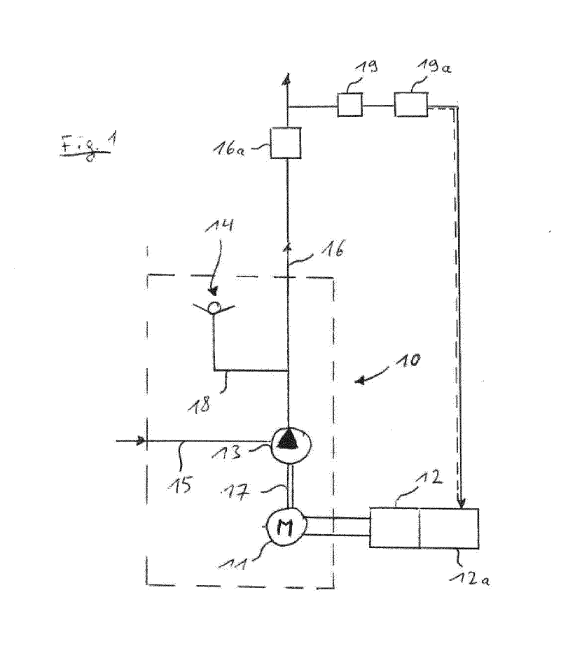

FIG. 1 shows a fluid delivery system 10. The fluid delivery system 10 is, in the exemplary embodiment, a fuel delivery system for delivering gasoline from a tank. In another embodiment, the fluid delivery system 10 may be configured to deliver diesel fuel. In the example of FIG. 1, the gasoline is supplied by the fluid delivery system ID to an injection system (so-called fuel rail system). For the sake of clarity, neither the tank nor the injection system are illustrated in FIG. 1. In the exemplary embodiment, the fluid delivery system is a so-called pre-delivery system. The fluid delivery system may likewise, in other embodiments, involve other fluid delivery systems or parts of a fluid delivery system.

In the exemplary embodiment, the fluid delivery system 10 comprises an electric motor 11. In the exemplary embodiment, the electric motor 11 is current-controlled- The electric motor 11 is activated by a motor controller 12. The motor controller is, in the exemplary embodiment, composed of an activation unit and of an additional processor 12a. The processor 12a is, in alternative embodiments, spatially separate from the motor controller 12 and thus located elsewhere. The electric motor 11 drives a fluid pump 13. In the exemplary embodiment, the fluid pump 13 is a fuel pump. The electric motor 11 is connected by a mechanical coupling 17 to the fluid pump 13. The fluid pump 13 pumps gasoline via a fluid line 15 from the tank through the fluid delivery system 10 and via a line 16 to the injection system. A calibration valve 14 is connected to an outlet side of the fluid pump 13 and is hydraulically coupled to the fluid pump 13. Here, the calibration valve 14 is connected by the hydraulic connection 18 to the line 16 and thus to the fluid pump 13. The calibration valve 14 is configured to open at a predetermined pressure, for example 8 bar. The electric motor 11 is controlled by the motor controller 12 such that the fluid pump 13 runs with a certain rotational speed of the motor 11. In an alternative embodiment, no calibration valve 14 is provided.

A filter 16a is installed in the line 16. The filter is in this case a fuel filter. In other embodiments, the filter may involve other filters or fluid-influencing components. The filter 16a may also, in a further embodiment be omitted.

Furthermore, a pressure sensor 19 is connected to the line 16. In the exemplary embodiment, the pressure sensor IS measures a fluid pressure in the line 16 downstream of the filter 16a. The signal of the pressure sensor 19 is evaluated in an evaluation unit 19a. The evaluation unit 19a provides an evaluated pressure signal to the motor controller 12, in the exemplary embodiment to the processor 12a of the motor controller, for plausibility checking.

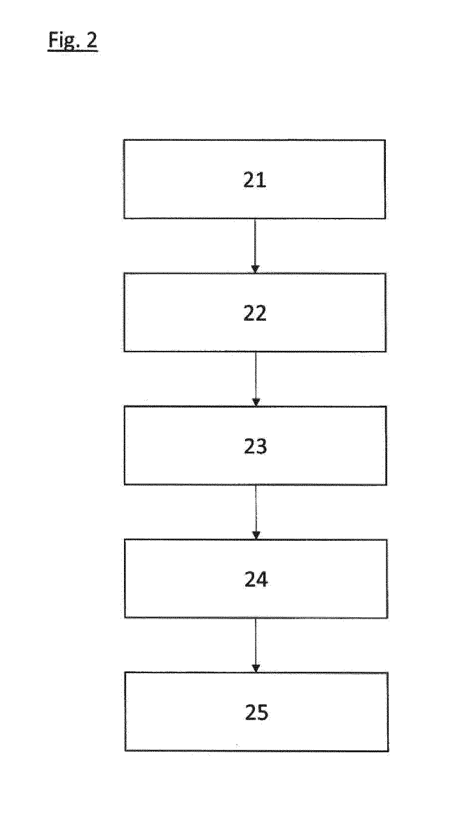

FIG. 2 shows a flow diagram for a method according to an embodiment of the invention. In the exemplary embodiment, an algorithm used for the execution of the method is stored in the processor 12a and is executed there as software. This is, however, not intended to restrict the invention. Accordingly, in other embodiments, it is possible for the calculations to be performed in the motor controller 12 or in other, separate units, such as for example an on-board computer of a vehicle.

In a first step 21, a rotational speed of the electric motor 11 is determined. Here, the rotational speed is determined, in a manner known per se, by a rotational speed sensor. It is alternatively possible for the rotational speed to be read out from an activation value of the motor controller 12.

In a step 22, a current of the electric motor 11 is determined. The current of the electric motor 11 is, in this case, determined by reading out the activation current from the motor controller 12. It is alternatively or additionally possible for the current to be determined by a measurement at a line of the electric motor 11.

In step 23, a pressure value is calculated as a function of the rotational speed of the current of the electric motor 11 and the calibration function. The calibration function, which is provided by the calibration valve 14, represents a relationship between the rotational speed and the current as a function of a pressure value. It is thus possible, with known pump characteristic curves, or a pressure-dependent pump characteristic map, to calculate a pressure value from the calibration function. In an alternative embodiment in which the calibration valve 14 is not provided, step 23 is omitted.

In step 24, the calculated pressure value is compared with a parameter. The parameter has the variable of a reference pressure value and is characteristic of a property of the fluid delivery system 10. For different applications of the method, different reference pressure values are stored in a table or in a memory in a manner dependent on which parameter the pressure value is to be compared with. A result of the comparison represents a pressure difference. For example, a calculated pressure is compared with a zero pressure value, such that the result of the comparison is the calculated pressure itself.

Here, parameters are to be understood to mean pressure values which, in the fluid delivery system 10, form limit values or define characteristic properties. For example, a parameter is a negative-pressure threshold, for the purposes of determining whether a negative pressure prevails. The negative-pressure threshold has for example a magnitude of 0.5 bar. This represents the reference pressure value in the above context. Further parameters are, for example, a positive-pressure threshold, a characteristic value for dry running of the fluid pump 13, a limit value beyond which a fluid pressure in the fluid delivery system 10 becomes unstable, a characteristic pressure value (inter alia also in a manner dependent on a setpoint delivery rate) indicative of a leak, or a characteristic pressure value that indicates so-called “gassing”.

The result from the step 24 serves for checking purposes. Here, it is verified whether a predefined value has been adhered to or whether the value has been exceeded. For example, a reference value that is expedient for the fluid delivery system 10 is 3 bar. In this case, a pressure in the fluid delivery system 10 of 2.5 bar is determined in step 23. Step 24 compares the determined pressure with the pressure in the fluid delivery system 10. The result of the comparison is in this case 0.5 bar. It is self-evidently likewise possible for the comparison to be performed on the basis of a product, a quotient or some other calculation module, such that the result may take a different form. The comparison is performed within the fluid delivery system 10, such that the check of the comparison takes place in the same way. In the example discussed, a reference of zero is specified, such that it is clear that the measured pressure deviates from the setpoint pressure by 0.5 bar. By the check, it can be identified that a negative pressure prevails, but not a positive pressure. Likewise, by the check of a pressure sensor, it can be verified that the pressure has been correctly measured. Since pressure still prevails, it can also be inferred that the pump has not yet run dry. If the pressure values are considered over a relatively long time period, it is also possible to infer whether a leak is present in the pump. By the pressure characteristic, it can additionally be identified whether “gassing” is occurring in the fluid delivery system 10.

If the fluid delivery system 10 comprises an additional pressure sensor 19, the two pressure values can be used for monitoring one another. The pressure sensor is thus monitored by a comparison with reference values.

In a step 25, the result is checked for plausibility. For example, if the pressure sensor indicates 0 bar and the method calculates the pressure as 2.3 bar, a fault is obviously present.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1-7. (canceled)

8. A method for checking a parameter correlating with a pressure in a pressure-dependent fluid delivery system (10), the fluid delivery system (10) having: a current-controlled electric motor (11) controlled by a motor controller (12), and a fluid pump (13) driven by the electric motor (11), the method comprising:
determining a rotational speed of the electric motor (11);
determining a current of the electric motor (11), by reading out an activation current of the motor controller (12);
calculating a pressure value as a function of the rotational speed and the current of the electric motor (11); and
comparing the calculated pressure value with the parameter.

9. The method as claimed in claim 8, further comprising:
checking for plausibility a result from the comparing, the checking being performed based on a predetermined reference value.

10. The method as claimed in claim 8, wherein a result from the comparing is characteristic of at least one selected from the group of the following events:
setting of a negative pressure in the fluid delivery system (10);
setting of s positive pressure in the fluid delivery system (10);
destabilization of a fluid pressure in the fluid delivery system (10);
dry running of the fluid pump (13);
occurrence of gas bubbles in the fluid delivery system (10), in particular gassing; and
occurrence of a leak in the fluid delivery system (10),

11. The method as claimed in claim 8, wherein the fluid delivery system (10) is pressure-controlled or rotational-speed-controlled.

12. The method as claimed in claim 8,
wherein:
the fluid delivery system has a calibration valve (14) arranged at an outlet side of the fluid pump (13) the calibration valve (14) being configured to open In a manner dependent on a predetermined pressure to provide a pressure-dependent calibration function, and
the calculating is dependent on the pressure-dependent calibration function.

13. A controller for a fluid delivery system (10) for gasoline or a fluid delivery system (10) for diesel, the controller being configured to carry out the method as claimed la claim 8.

14. A fluid delivery system (10), comprising:
an electric motor (11);
a motor controller (12);
a fluid pump (13); and
a calibration valve (14),
wherein:
the electric motor (11) is configured to drive the fluid pump (13),
the calibration valve is arranged at an outlet side of the fluid pump (13) and opens in a manner dependent on a predetermined pressure, and
the motor controller (12) is configured to activate the electric motor (11) with an activation current on the basis of a throughflow regulation algorithm, wherein monitoring and/or plausibility checking of the fluid delivery system (10) is performed by the method as claimed in claim 8.
